(19) United States
(12) Patent Application Publication
(10) Pub. No.: US 2020/0131308 A1
(43) Pub. Date: Apr. 30, 2020

(54) POLYESTER MIXTURE AND MANUFACTURING METHOD FOR POLYESTER

(71) Applicant: Far Eastern New Century Corporation, Taipei (TW)

(72) Inventors: Der-Ren HWANG, Taoyuan City (TW); Cheng-Ting WANG, Taoyuan City (TW); Hsiao-Chan WANG, Taoyuan City (TW); Yi-Chen LEE, Taoyuan City (TW)

(21) Appl. No.: 16/394,296

(22) Filed: Apr. 25, 2019

(30) Foreign Application Priority Data
Oct. 25, 2018 (TW) 107137830

(51) Int. Cl. C08G 63/183

(52) U.S. Cl. CPC C08G 63/183

(57) ABSTRACT

A method for manufacturing polyester comprises mixing Bis(2-Hydroxyethyl) terephthalate monomer with terephthalic acid to form a mixture, in which the Bis(2-Hydroxyethyl) terephthalate monomer is represented by formula (I) below:

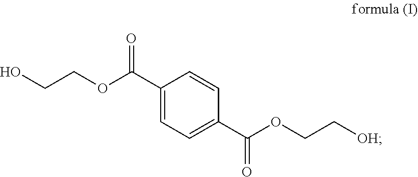 [SMILES: O=C(OCCO)c1ccc(C(=O)OCCO)cc1]

esterifying the mixture to form a first polyester mixture; and polymerizing the first polyester mixture to form a second polyester mixture, in which the second polyester mixture has a diethylene glycol concentration of less than 1 wt % but greater than 0.1 wt %, based on the total weight of the second polyester mixture, and a polydispersity index of polyethylene terephthalate in the second polyester mixture is less than 3 but greater than 2.

### CROSS-REFERENCE TO RELATED APPLICATION

This application claims priority to Taiwan Application Serial Number 107137830, filed Oct. 25, 2018, which is herein incorporated by reference in its entirety.

### BACKGROUND

### Field of Invention

The present invention relates to polyester and a manufacturing method thereof. More particularly, the present invention relates to a polyester with a fast crystallization rate without using nucleating agents and the method for manufacturing the same.

### Description of Related Art

Polyethylene terephthalate (also referred to as PET) has excellent toughness, stretchability, impact resistance, wear resistance and electrical insulation, and thus it is widely used in various plastic products.

However, the crystallization rate of PET is slow since the main chain of the PET is rigid and the polymer chains move slowly during the crystallization processes. As a result, processing and molding the PET are time consuming. The process not only decreases the production rate but also increases the manufacturing cost.

One skilled in the art usually adds a nucleating agent (e.g., metal oxides, inorganic salt compounds and carboxylate compounds) into the PET to enhance the crystallization rate. Nevertheless, the addition of the nucleating agent leads to problems in poor mechanical properties and difficulties in recycling the PET.

In view of the above issues, there is a need for a solution that can increase the crystallization rate of the PET.

### SUMMARY

The invention provides a manufacturing method of polyester. The manufacturing method includes: mixing Bis(2-Hydroxyethyl) terephthalate monomer with terephthalic acid to form a mixture, in which the Bis(2-Hydroxyethyl) terephthalate monomer is represented by formula (I) below,

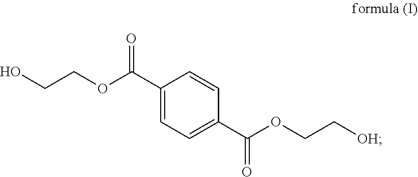 [SMILES: O=C(OCCO)c1ccc(C(=O)OCCO)cc1]

esterifying the mixture to form a first polyester mixture; and polymerizing the first polyester mixture to form a second polyester mixture, in which the second polyester mixture has a diethylene glycol concentration of greater than 0.1 wt % but less than 1 wt %, based on the total weight of the second polyester mixture, and a polydispersity index (PDI) of polyethylene terephthalate in the second polyester mixture is greater than 2 but less than 3.

According to an aspect of the present invention, the mixing the Bis(2-Hydroxyethyl) terephthalate monomer with the terephthalic acid to form the mixture includes mixing an alkaline substance with the Bis(2-Hydroxyethyl) terephthalate monomer and the terephthalic acid.

According to an aspect of the present invention, the alkaline substance includes tetraethylammonium hydroxide.

According to an aspect of the present invention, the second polyester mixture has an intrinsic viscosity in a range from 0.5 to 0.8.

According to an aspect of the present invention, the polymerizing the first polyester mixture to form the second polyester mixture includes adding a catalyst into the first polyester mixture.

According to an aspect of the present invention, a molar ratio of the Bis(2-Hydroxyethyl) terephthalate monomer to the terephthalic acid ranges from 1.31:1 to 1.09:1.

According to an aspect of the present invention, the first polyester mixture includes Bis(2-Hydroxyethyl) terephthalate oligomer.

According to an aspect of the present invention, the first polyester mixture further includes diethylene glycol.

According to an aspect of the present invention, the manufacturing method is devoid of a step of adding nucleating agents.

The invention also provides a polyester mixture, which includes polyethylene terephthalate and diethylene glycol. The polyethylene terephthalate has a polydispersity index of greater than 2 but less than 3. The diethylene glycol has a weight percentage of greater than 0.1 wt % but less than 1 wt %, based on a total weight of the polyester mixture.

According to an aspect of the present invention, the polyester mixture has an intrinsic viscosity in a range from 0.5 to 0.8.

These and other features, aspects, and advantages of the present invention will become better understood with reference to the following description and appended claims.

It is to be understood that both the foregoing general description and the following detailed description are by examples, and are intended to provide further explanation of the invention as claimed.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the dimensions of the elements are not limited by the scope or value of the disclosure, but may depend on the process conditions and/or desired characteristics of the elements.

In some comparative examples in this disclosure, the crystallization rate of polyester may be increased by several ways. For example, nucleating agents (also referred to as crystallization accelerators) are added during the polyester manufacturing process. The nucleating agents may be crystal seeds for heterogeneous nucleation in the polyester crystallization. The nucleating agents include organic nucleating agents and inorganic nucleating agents.

However, the inorganic nucleating agents, such as metal oxides and inorganic salts, may cause the degradation of the polyesters. Since the inorganic nucleating agents have poor compatibility with the polyesters, they are difficult to disperse uniformly in the polyesters. As a result, the quality of obtained products deteriorates.

Illustrative examples of the organic nucleating agents with low molecular weight include sodium carboxylate and aromatic sulfonate. For example, sodium benzoate (a type of sodium carboxylate) may react with polyethylene terephthalate (PET) to form sodium salt, resulting in a decrease in the molecular weight of the PET. Accordingly, the mechanical properties and heat property of the produced products deteriorate.

On the other hand, the organic nucleating agents with high molecular weight, such as polymers with ionicity and polyester alkali metal salts, may decrease the molecular weight of the PET as well. Moreover, the addition of the polymeric nucleating agents undesirably increases the difficulties in recycling the PET.

The present invention provides a manufacturing method of polyester. It significantly increases the crystallization rate of the polyester, in which no nucleating agent is required. Further, both the processing time and the difficulties in manufacture are reduced.

In an embodiment of the present invention, Bis(2-Hydroxyethyl) terephthalate monomer and terephthalic acid are used as raw materials. The Bis(2-Hydroxyethyl) terephthalate monomer has a structure represented by formula (I):

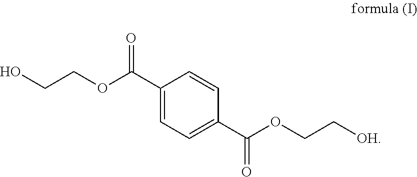 [SMILES: O=C(OCCO)c1ccc(C(=O)OCCO)cc1]

In certain embodiments, the Bis(2-Hydroxyethyl) terephthalate monomer may be obtained from alcoholysis of polyethylene terephthalate using ethylene glycol. In other embodiments, the Bis(2-Hydroxyethyl) terephthalate monomer may be obtained from a reaction of terephthalic acid with ethylene oxide.

In the manufacturing method disclosed herein, the Bis(2-Hydroxyethyl) terephthalate monomer is mixed with terephthalic acid to form a mixture. In some embodiments, the Bis(2-Hydroxyethyl) terephthalate monomer has a chemical structure represented by formula (I) illustrated hereinbefore.

It is noted that, in some comparative examples of the present invention, a mixture obtained from an esterification reaction of terephthalic acid and ethylene glycol includes Bis(2-Hydroxyethyl) terephthalate oligomer. In these comparative examples, the produced Bis(2-Hydroxyethyl) terephthalate oligomer has various degrees of polymerization, and thus is different from the Bis(2-Hydroxyethyl) terephthalate monomer used in the embodiments of the present disclosure. In some embodiments, only the Bis(2-Hydroxyethyl) terephthalate monomer and the terephthalic acid are used as raw materials. In examples, a molar ratio of the Bis(2-Hydroxyethyl) terephthalate monomer to the terephthalic acid ranges from about 1.31:1 to about 1.09:1.

In some embodiments, the step of forming the mixture comprising the Bis(2-Hydroxyethyl) terephthalate monomer and the terephthalic acid further includes mixing an alkaline substance with the Bis(2-Hydroxyethyl) terephthalate monomer and the terephthalic acid. In other words, the mixture includes the alkaline substance, the Bis(2-Hydroxyethyl) terephthalate monomer and the terephthalic acid. In certain embodiments, the alkaline substance may be tetraethylammonium hydroxide.

After the mixture is formed, the mixture is subjected to an esterification reaction to produce a first polyester mixture. In certain embodiments, the first polyester mixture includes diethylene glycol. In some embodiments, the first polyester mixture includes diethylene glycol and Bis(2-Hydroxyethyl) terephthalate oligomer.

The diethylene glycol is a by-product of a side reaction in the production of polyester. As the content of diethylene glycol increases, the processability and mechanical properties of the polyester decrease. Accordingly, while the content of diethylene glycol becomes lower, the processability and mechanical properties of the polyester become better. The manufacturing method disclosed herein lowers the amount of diethylene glycol undesirably produced in the production of polyester, and thus the diethylene glycol content in the polyester is reduced. In addition, an alkaline substance may be added during the reaction to further reduce the yield of the diethylene glycol, according to some embodiments of the present invention. In certain embodiments, the yield of the diethylene glycol may be decreased by decreasing the amount of the ethylene glycol used in the reaction process.

After the formation of the first polyester mixture, the first polyester mixture is subjected to a polymerization to form a second polyester mixture. In some embodiments, a catalyst may be added during the polymerization to increase the reaction rate of the polymerization. In certain embodiments, the catalyst includes antimony trioxide (Sb₂O₃). In certain embodiments, an ethylene glycol solution containing phosphoric acid (serving as a stabilizer) may be added to first polyester mixture during the polymerization. By the polymerization, the molecular weight of the polyester is increased, and the viscosity of the obtained second polyester mixture is also increased.

After the polymerization, the diethylene glycol in the second polyester mixture is less than 1 wt % but greater than 0.1 wt %, such as 0.2 wt %, 0.5 wt % or 0.7 wt %, based on the total weight of the second polyester mixture. The polyethylene terephthalate in the second polyester mixture has a polydispersity index of about 2 to about 3, such 2, 2.2, 2.5, 2.7 or 3. In some embodiments, the second polyester mixture has an intrinsic viscosity (IV) of about 0.5 to about 0.8.

### Embodiment 1

Bis(2-Hydroxyethyl) terephthalate monomer (1873.8 g) was mixed with terephthalic acid (936.9 g) in a reactor. The mixture of Bis(2-Hydroxyethyl) terephthalate monomer and the terephthalic acid was subjected to an esterification in a nitrogen atmosphere to form a first polyester mixture. Specifically, the reactor was purged with nitrogen gas to replace the air inside the reactor. The esterification was performed at a temperature of 260′C under a pressure of about 1 atm. Thereafter, antimony trioxide (0.748 g) and an ethylene glycol solution (3.75 g) containing 5 wt % of phosphoric acid were added into the obtained first polyester mixture, followed by a polymerization of the mixture in the reactor to produce a second polyester mixture. The polymerization was performed at a temperature of 275° C. until the intrinsic viscosity of the obtained second polyester mixture was greater than 0.57.

### Embodiment 2

Bis(2-Hydroxyethyl) terephthalate monomer (1653.7 g) was mixed with terephthalic acid (1080.8 g), ethylene glycol (403.7 g) and tetraethylammonium hydroxide (1.25 g) in a reactor. The mixture in the reactor was subject to an esterification to produce a first polyester mixture. Particularly, the esterification was performed at a temperature of 260° C. under a pressure of 2 kg/cm² in a nitrogen environment. Thereafter, antimony trioxide (0.748 g) and an ethylene glycol solution (3.75 g) containing 5 wt % of phosphoric acid were added into the first polyester mixture, followed by a polymerization of the mixture in the reactor to produce a second polyester mixture. The polymerization was performed at a temperature of 275° C. until the intrinsic viscosity of the obtained second polyester mixture was greater than 0.57.

### Comparative Example 1

Terephthalic acid (2161.5 g) was mixed with ethylene glycol (1009.1 g) in a reactor. The mixture in the reactor was subject to an esterification to produce a first polyester mixture. The esterification was performed at a temperature of 260° C. under a pressure of 2 kg/cm² in a nitrogen environment. Thereafter, antimony trioxide (0.748 g) and ethylene glycol solution (3.75 g) containing 5 wt % of phosphoric acid were added into the first polyester mixture, followed by a polymerization of the mixture in the reactor to produce a second polyester mixture. The polymerization was performed at a temperature of 275° C. until the intrinsic viscosity of the obtained second polyester mixture was greater than 0.57.

### Comparative Example 2

Terephthalic acid (2161.5 g) was mixed with ethylene glycol (1009.1 g) in a reactor. The mixture in the reactor was subject to an esterification to produce a first polyester mixture. The esterification was performed at a temperature of 260° C. under a pressure of 2 kg/cm² in a nitrogen environment. Thereafter, antimony trioxide (0.748 g) and an ethylene glycol solution (3.75 g) containing 5 wt % of phosphoric acid were added into the first polyester mixture, followed by a polymerization of the mixture in the reactor to produce a second polyester mixture. The polymerization was performed at a temperature of 275° C. until the intrinsic viscosity of the obtained second polyester mixture was greater than 0.57.

### Comparative Example 3

Bis(2-Hydroxyethyl) terephthalate monomer (1813.9 g) was mixed with terephthalic acid (936.9 g) and diethylene glycol (25 g) in a reactor. The mixture in the reactor was subjected to an esterification to form a first polyester mixture. Specifically, the reactor was purged with nitrogen to replace the air inside the reactor. The esterification was performed at a temperature of 260° C. under a pressure of about 1 atm. Thereafter, antimony trioxide (0.748 g) and 5 wt % phosphoric-acid-contained ethylene glycol solution (3.75 g) containing 5 wt % of phosphoric acid were added into the obtained first polyester mixture, followed by a polymerization of the mixture in the reactor to form a second polyester mixture. The polymerization was performed at a temperature of 275° C. until an intrinsic viscosity of the obtained second polyester mixture was greater than 0.57.

### Comparative Example 4

Terephthalic acid (2161.5 g) was mixed with ethylene carbonate (1375.8 g) in a reactor. The mixture of the terephthalic acid and the ethylene carbonate was subjected to an esterification to form a first polyester mixture. The esterification is performed at a temperature of 260° C. and under a pressure of 2 kg/cm² in a nitrogen environment. Thereafter, antimony trioxide (0.748 g) and an ethylene glycol solution (2.8 g) containing 5 wt % of phosphoric acid are added into the first polyester mixture, followed by a polymerization of the mixture in the reactor to produce a second polyester mixture. The polymerization was performed at a temperature of 275° C. until an intrinsic viscosity of the second polyester mixture was greater than 0.57.

### Embodiment 3

The second polyester mixture obtained in Embodiment 1 was mixed with the second polyester mixture obtained in Comparative Example 4 to produce a second polyester mixture of Embodiment 3.

The experimental data of the embodiments and comparative examples of the present invention are summarized in Table 1 below. In detail, the experimental data includes the intrinsic viscosity of the second polyester mixture, the content of the diethylene glycol in the second polyester mixture, the polydispersity index of the PET in the second polyester mixture, and the melting point (Tₘ), crystallization point (T_{cc}) and degree of undercooling (Tₘ−T_{cc}) of the PET crystal in the second polyester mixture. To be more precisely, the degree of undercooling of the PET crystal is the difference between the melting point and the crystallization point. The degree of undercooling is an indicator of the crystallizability of polymer. The less the degree of undercooling is, the shorter the initiation time period of crystallization of the polymer becomes and the faster the rate of crystallization is. In general, the degree of undercooling needs to be less than 40° C. to achieve rapid crystallization and effectively shorten the processing time. To the contrary, the crystallization of polymer becomes more difficult and the rate of crystallization becomes slower if the degree of undercooling is greater than 40° C.

TABLE 1

| | | | | | | degree of |
|---|---|---|---|---|---|---|
| | | diethylene | | melting | crystal- | under- |
| | | glycol | | point | lization | cooling |
| | IV | (wt%) | PDI | (Tₘ) | point (T_{cc}) | (Tₘ − T_{cc}) |
| Embodiment | 0.579 | 0.66 | 2.374 | 252.86 | 218.14 | 34.72 |
| 1 | | | | | | |
| Embodiment | 0.596 | 0.64 | 2.430 | 249.69 | 209.09 | 37.60 |
| 2 | | | | | | |
| Embodiment | 0.563 | 0.60 | 2.438 | 254.10 | 219.32 | 34.78 |
| 3 | | | | | | |
| Comparative | 0.606 | 3.47 | 1.742 | 244.28 | 185.03 | 59.25 |
| Example 1 | | | | | | |
| Comparative | 0.626 | 4.05 | 1.783 | 242.56 | 189.48 | 53.08 |
| Example 2 | | | | | | |
| Comparative | 0.595 | 1.76 | 2.020 | 245 | 202.87 | 42.13 |
| Example 3 | | | | | | |
| Comparative | 0.630 | 0.52 | 1.6 | 254.9 | 196.4 | 58.5 |
| Example 4 | | | | | | |

In Embodiment 1, Bis(2-Hydroxyethyl) terephthalate monomer and terephthalic acid were used as the raw materials. The degree of undercooling of the produced PET is 34.72° C., which is less than 40° C. The result shows that Embodiment 1 provides excellent crystallization rate.

As regards to Embodiment 2, the tetraethylammonium hydroxide was used as an alkaline substance to suppress the formation of diethylene glycol. The degree of undercooling of the produced PET is 37.60° C., which is less than 40° C. The result shows that Embodiment 2 also provides excellent crystallization rate.

In Embodiment 3, the second polyester mixtures of Embodiment 1 and Comparative Example 4 were mixed. Similar to Embodiment 1 and 2, the degree of undercooling of Embodiment 3 is less than 40° C. Therefore, Embodiment 3 provides superb crystallization as well.

The results of Embodiment 1-3 show that the produced second polyester mixture needs to meet two requirements to achieve rapid crystallization rate: (1) the content of the diethylene glycol is less than 1 wt %; and (2) the PDI of the PET is greater than 2.

In Comparative Example 1 and Comparative Example 2, however, the terephthalic acid and the ethylene glycol were used as raw materials. The content of diethylene glycol is greater than 1 wt % and the PDI of the PET in the produced second polyester mixture is less than 2. Thus, the degrees of undercooling of the PETs of Comparative Example 1 and Comparative Example 2 are too high (greater than 40° C.).

As to Comparative Example 3, although the PDI of the PET is greater than 2, the content of the diethylene glycol is greater than 1 wt %. Therefore, the degree of undercooling of the PET of Comparative Example 3 is also too high (greater than 40° C.).

In Comparative Embodiment 4, the content of the diethylene glycol is less than 1 wt %, but the PDI of the PET is less than 2. Accordingly, the degree of undercooling of the PET of Comparative Example 4 is still too high (greater than 40° C.).

Comparative Example 3 and Comparative Example 4 show that the degree of undercooling of the PET is still too high (greater than 40° C.) if only one of the requirements mentioned above is satisfied. For example, the PDI of the PET is greater than 2, but the content of the diethylene glycol is greater than 1 wt % (such as Comparative Example 3). Alternatively, the content of the diethylene glycol is less than 1 wt %, but the PDI of the PET is less than 2 (such as Comparative Example 4). In other words, the polyester shows a rapid crystallization rate only if both of the two requirements mentioned above are satisfied.

The present invention also provides a polyester mixture. The polyester mixture includes polyethylene terephthalate and diethylene glycol. The polyethylene terephthalate has a polydispersity index of greater than 2 but less than or equal to 3, for example 2, 2.2, 2.5, 2.7 or 3. The content of the diethylene glycol in the polyester mixture is less than 1 wt % but greater than 0.1 wt %, for example 0.2 wt %, 0.5 wt % or 0.7 wt %.

In some embodiments, the polyester mixture has an intrinsic viscosity ranged from about 0.5 to about 0.8.

The polyester mixture of the present invention is capable of self-nucleation. Thus, no additional additive is needed, and the manufacturing cost is reduced and manufacturing processes are simplified. Besides, the issue of the dispersion of the nucleating agent in the polyester is also avoided. As mentioned above, the present invention provides a polyester mixture with a rapid crystallization rate. In other words, the crystallization rate is significantly increased, thereby decreasing the production time and the difficulties in the manufacturing processes.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A manufacturing method of polyester, comprising:
mixing Bis(2-Hydroxyethyl) terephthalate monomer with terephthalic acid to form a mixture, wherein the diethylene terephthalate monomer is represented by formula (I) below: 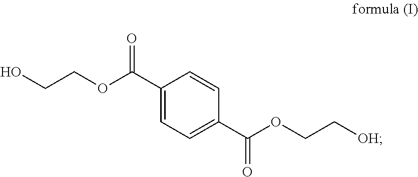 [SMILES: O=C(OCCO)c1ccc(C(=O)OCCO)cc1]
esterifying the mixture to form a first polyester mixture; and
polymerizing the first polyester mixture to form a second polyester mixture, wherein the second polyester mixture has a diethylene glycol concentration of greater than 0.1 wt % but less than 1 wt %, based on the total weight of the second polyester mixture, and a polydispersity index of polyethylene terephthalate in the second polyester mixture is greater than 2 but less than 3.

2. The manufacturing method of claim 1, wherein the mixing the Bis(2-Hydroxyethyl) terephthalate monomer with the terephthalic acid to form the mixture comprises mixing an alkaline substance with the Bis(2-Hydroxyethyl)terephthalate monomer and the terephthalic acid.

3. The manufacturing method of claim 2, wherein the alkaline substance comprises tetraethylammonium hydroxide.

4. The manufacturing method of claim 1, wherein the second polyester mixture has an intrinsic viscosity in a range from 0.5 to 0.8.

5. The manufacturing method of claim 1, wherein the polymerizing the first polyester mixture to form the second polyester mixture comprises adding a catalyst into the first polyester mixture.

6. The manufacturing method of claim 1, wherein a molar ratio of the Bis(2-Hydroxyethyl) terephthalate monomer to the terephthalic acid ranges from 1.31:1 to 1.09:1.

7. The manufacturing method of claim 1, wherein the first polyester mixture comprises Bis(2-Hydroxyethyl) terephthalate oligomer.

8. The manufacturing method of claim 7, wherein the first polyester mixture further comprises diethylene glycol.

9. The manufacturing method of claim 1, wherein the manufacturing method is devoid of a step of adding nucleating agents.

10. A polyester mixture, comprising:
polyethylene terephthalate having a polydispersity index of greater than 2 but less than 3; and
diethylene glycol, wherein the diethylene glycol has a weight percentage of greater than 0.1 wt % but less than 1 wt %, based on a total weight of the polyester mixture.

11. The polyester mixture of claim 10, wherein the polyester mixture has an intrinsic viscosity in a range from 0.5 to 0.8.
